(19) United States
(12) Patent Application Publication
(10) Pub. No.: US 2026/0175342 A1
(43) Pub. Date: Jun. 25, 2026

(54) STOP MODULE

(71) Applicant: Asutec GmbH, Nürtingen (DE)

(72) Inventors: Andreas UNTERHUBER, Köngen (DE); Martin POHLE, Kirchheim unter Teck (DE)

(21) Appl. No.: 19/068,399

(22) Filed: Mar. 3, 2025

(30) Foreign Application Priority Data
Dec. 19, 2024 (DE) 10 2024 138 975.3

(51) Int. Cl. B23Q 16/00; B65G 47/88

(52) U.S. Cl. CPC B23Q 16/008; B65G 47/8815; B65G 2205/06

(57) ABSTRACT

A stop module with a stop element that is movably mounted on a base body for objects moving in a transport plane. The stop element can be moved out of the transport plane and back into it by means of an actuating device including an actuating drive and a damping device coupled to the stop element, such that the stop member is movable in a damped manner upon impact of the object out of a stop member initial position in the direction of a stop member end position preventing further movement of the stop member. The actuating device has a mechanical control element which is coupled to a mechanical counter-control element arranged on the stop element in such a way that when the object impacts, the actuating drive can be activated by activation means and causes the mechanical control element to execute a control movement.

### CROSS REFERENCE TO RELATED APPLICATION

The present application claims the benefit of German application DE 102024138975.3, filed Dec. 19, 2024, which is incorporated herein by reference.

### BACKGROUND OF THE INVENTION

The invention relates to a stop module, in particular for automatic processing and conveying equipment, having a stop element that is mounted on a base body such that it can move for objects that move in a movement plane in an actual working movement direction oriented along a movement axis, wherein the stop element can be moved out of the movement plane by means of a downward stroke and back into it by means of an upward stroke by means of an actuating device that has an actuating drive, and with a damping device coupled to the stop element for damping the impact of an object on the stop element, in such a way that the stop element is dampedly movable upon impact of the object from a stop element initial position in the direction of a stop element end position preventing further movement of the stop element.

Fluid-actuated stop modules are already known, for example from EP 0 484 648. The stop element described therein can be moved out of and into the path of approaching workpieces by means of a pneumatically actuated piston. A compressed air connection is provided on the housing for the compressed air supply, via which compressed air is supplied in a controlled manner. Furthermore, a damping device is assigned to the stop so that the movement of the striking workpieces can be damped. The extension of the stop element from an end stop position to a first stop position is also achieved by the controlled supply of compressed air.

Such stop modules, which can also be referred to as separating stops, can be categorised as either damped or undamped stop modules. In the case of the undamped stop modules, the object moving in the direction of the working movement, which may be a workpiece pallet loaded with workpieces, for example, strikes the stop element protruding into the plane of movement without damping and with force. The damped stop modules are provided with a damping device that slows down the retracting movement of the stop element from the stop element initial position to a stop element end position or stop position. Damped stop modules are particularly suitable for heavy objects that need to be separated. Generally, the damped stop modules are designed for the object with the highest weight, whereby the impact of this object can still be reliably damped or decelerated. In this process, the stop element is moved from the stop element initial position to the stop element end position. However, the problem with such damped attachment modules is that, in the case of incoming objects that are relatively light in weight, the stop element is not moved completely from the stop element initial position to the stop element end position, but is instead slowed down beforehand, causing the stop element to stop before reaching the stop element end position. If the stop element is not moved completely into the stop element end position by the total energy of the incoming object, the stop element will therefore remain somewhere between the stop element initial position and the stop element end position, depending on the total energy and primarily on the weight of the incoming object. This is disadvantageous for the subsequent handling of the object.

### SUMMARY OF THE INVENTION

The object of the invention is therefore to create a stop module of the type mentioned at the beginning, in which the stop element is reliably moved to a defined end position during the damping or braking process of the object, thus avoiding the above-mentioned disadvantages of the prior art.

This task is solved by a stop module with the features of the independent claim 1. Further developments of the invention are shown in the sub-claims.

The stop module according to the invention is characterised by the fact that the control device has a mechanical control element that is coupled in motion to the control drive and driven by it, and that is coupled to a mechanical counter-control element arranged on the stop element in such a way that when the object strikes the actuating drive, the actuating drive can be activated by activation means and causes the mechanical control element to execute a control movement, whereby the stop element can be moved from the stop element starting position into the stop element end position by means of the pick-up by means of the mechanical counter-control element.

This control movement therefore always ensures that the stop element is moved into the stop element end position, i.e. into a defined end position, during the braking or damping process. This occurs independently of the weight of the incoming object. Thus, if a heavy object for which the stop module is designed arrives, the kinetic energy will be sufficient to move the stop element completely from the stop element initial position to the stop element end position without the counter control element on the stop element coming into contact with the control element. In the case of lighter objects, the impact of which would cause the stop element to remain between the stop element initial position and the stop element end position, this situation is prevented by the stop element being moved to the stop element end position by the control movement performed in combination with the mechanical control element and the mechanical counter-control element. This prevents the stop element from stopping between the two end positions, i.e. the stop element initial position and the stop element end position.

In a further development of the invention, the mechanical control element and the mechanical counter-control element are designed as a control bolt and a damping control link equipped with a control track for the control bolt. The control track can be designed as a cam track, for example, but a linearly running control track is also possible. It is expedient for the control track to be part of a control surface.

The damping control link is arranged on the mechanical control element and the control bolt is arranged on the mechanical counter-control element in a particularly preferred manner.

In a particularly preferred manner, the mechanical control element is movable by control movement, when the actuator is activated, from a control element initial position, corresponding with the stop element initial position, into a control element damping end position, corresponding with the stop element end position.

In a further development of the invention, the control track of the damping control link is designed as an axial lead surface with a lead running axially to the axis of movement, which, starting from the basic position of the mechanical control element, rises towards the damping end position of the control element in the direction of the basic body.

In a further development of the invention, the mechanical control element also takes over the control of the lowering movement of the striking element out of the movement plane via lowering control means in addition to controlling the damping movement of the striking element. The mechanical control element is therefore a multifunctional component that can be used both for damping control and for lowering control of the striking element.

In a further development of the invention, the lowering control means comprise a lowering control link and a lowering control bolt.

In a particularly preferred embodiment, the mechanical control element is configured as a control disc that can be rotated about an axis of rotation, wherein the control element damping end position can be reached from the control element basic position by rotating the control disc through a certain angle of rotation, for example by rotating it through 180°. Consequently, when the actuating drive is activated, the control disc can move the stop element into the stop element damping end position by means of a rotary movement through a specific angle of rotation.

In a further development of the invention, the damping control link is formed on the control disc on a first end face of the control disc facing towards the base body. The axial lead surface can therefore be formed on this front disc surface. Accordingly, the lateral surface of the control disc can widen starting from the control element initial position to the control element damping end position.

In a further development of the invention, the lowering control means are formed by the control disc and the control bolt, in such a way that the control disc can be rotated further through a specific angle of rotation starting from the control element damping end position towards a control element lowering end position, wherein during the rotation the control bolt can be guided along a radial pitch surface extending radially to the axis of movement and formed on the lowering control link. It is therefore expedient for the axial lead surface on the control disc to be followed by a radial lead surface. The axial lead surface is therefore used for controlling the damping, while the radial control surface is used for controlling the lowering.

In a further development of the invention, the mechanical control element is designed as a carriage that can be moved along a linear axis that is preferably perpendicular to the axis of movement, on which the control link is formed.

The actuator for initiating the control movement on the carriage can be designed as a linear actuator.

In a further development of the invention, the activation means comprise at least one sensor for detecting the impact of an object on the stop member and an electronic control unit, wherein the electronic control unit is suitable for receiving sensor signals transmitted by the sensor, in particular in the event of an impact, and for outputting activation signals for activating the actuating drive.

In a further development of the invention, the actuating drive is designed as an electric actuating drive, preferably an electric motor, in particular a geared stepper motor.

In a further development of the invention, the actuating drive has an output shaft that can be driven in rotation, the rotary drive movement of which can be transmitted to the control disc via a keyed connection. In the case of a design of the mechanical control element as a linearly movable slide, the rotational drive movement can be translated via a transmission, for example in the form of a transmission gear, into a translational or linear movement for the slide. Alternatively, it is possible to introduce a linear drive movement to the slide by means of a linear drive.

In a further development of the invention, the damping device has a shock absorber coupled to the stop element. It is advantageous for the shock absorber to be designed as a hydraulic shock absorber. However, pneumatic shock absorbers can also be used.

In a particularly preferred manner, the stop element is assigned first spring means for prestressing the stop element into the stop element initial position, wherein the spring means are preferably components of the damping device, in particular are integrated into the shock absorber. If no object is attached, the stop element is therefore in the stop element initial position as a result of the spring force of the spring means. When the load acting on the stop element in the direction of movement is removed by an attached object, the stop element remains in the stop element damping end position, i.e. it remains locked. Only when the control element is moved out of the control element damping end position can the stop element be automatically reset to the stop element initial position as a result of the spring force of the spring means. One advantage of this design is that it is possible to handle the object, in particular the workpiece holder, for example to lift it off the transport device, without the position of the stop element changing, whereby the object can be returned to its previous position with precise positioning after the handling process.

In a further development of the invention, second spring means acting in the opposite direction to the downward stroke are assigned to the stop member for prestressing the stop member into the stop member initial position projecting into the plane of movement. It is expedient for the spring means to be integrated into the base body and to be supported on the one hand on the base body and on the other hand on the stop member. The spring force of the second spring means thus counteracts the downward stroke, whereby the stop element can be automatically returned to the stop element initial position by the spring force of the second spring means.

### BRIEF DESCRIPTION OF THE DRAWINGS

Preferred embodiments of the invention are shown in the drawings and are explained in more detail below. The drawings show:

FIG. 1 a perspective view of a first embodiment of the invention of the stop module,

FIG. 2 a side view of the stop module of FIG. 1 mounted on a transport device,

FIG. 3 a perspective view of the transport device of FIG. 2, with the stop member of the stop module in the lowered position,

FIG. 4 an end view of the stop module from FIG. 1,

FIG. 5 a longitudinal section through the stop module from FIG. 1 along the line V-V in FIG. 4,

FIG. 6 a perspective view of the mechanical control element in the form of a control disc of the stop module from FIG. 1,

FIG. 7 an exploded view of the stop module of FIG. 1,

FIG. 8 a side view of the control disc of FIG. 6,

FIG. 9 an exploded view of the stop module of FIG. 1, viewed from the other end face,

FIG. 10 a side view of the stop module of FIG. 1 with the stop element in the stop element initial position and the control disc in the control element basic position,

FIG. 11 a section through the control disc along lines XI-XI from FIG. 10,

FIG. 12 a side view of the stop module from FIG. 1, with the stop element in the stop element end position and the control disc in the control element damping end position,

FIG. 13 a section through the control disc along lines XIII-XIII in FIG. 12,

FIG. 14 a side view of the stop module from FIG. 1, with the stop element in the lowered release position and the control disc in a further intermediate position,

FIG. 15 a section through the control disc along lines XV-XV in FIG. 14,

FIG. 16 a perspective view of a second embodiment of the stop module according to the invention,

FIG. 17 a longitudinal section through the stop module along line XVII-XVII in FIG. 18, with the stop element in the stop element initial position,

FIG. 18 a front view of the abutment module from FIG. 16,

FIG. 19 a longitudinal section through the abutment module from FIG. 20 along lines XIX-XIX in FIG. 20,

FIG. 20 a partially cut front view of the abutment module from FIG. 16,

FIG. 21 a horizontal section through the attachment module of FIG. 16 along line XXI-XXI in FIG. 18,

FIG. 22 a horizontal section through the attachment module of FIG. 16 along line XXII-XXII in FIG. 20,

FIG. 23 a front view, partially cut, similar to the front view of FIG. 29, whereas the stop element is in the lowered release position,

FIG. 24 a perspective view of the mechanical control element in the form of the control carriage,

FIG. 25 a plan view of the control carriage of FIG. 24 and

FIG. 26 a rear view of the control slide from FIG. 24.

### DETAILED DESCRIPTION

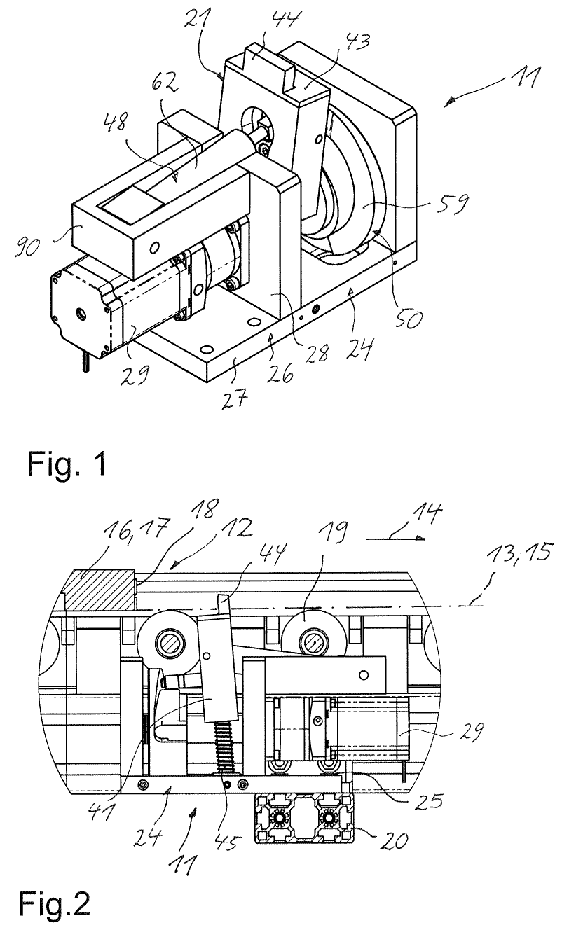

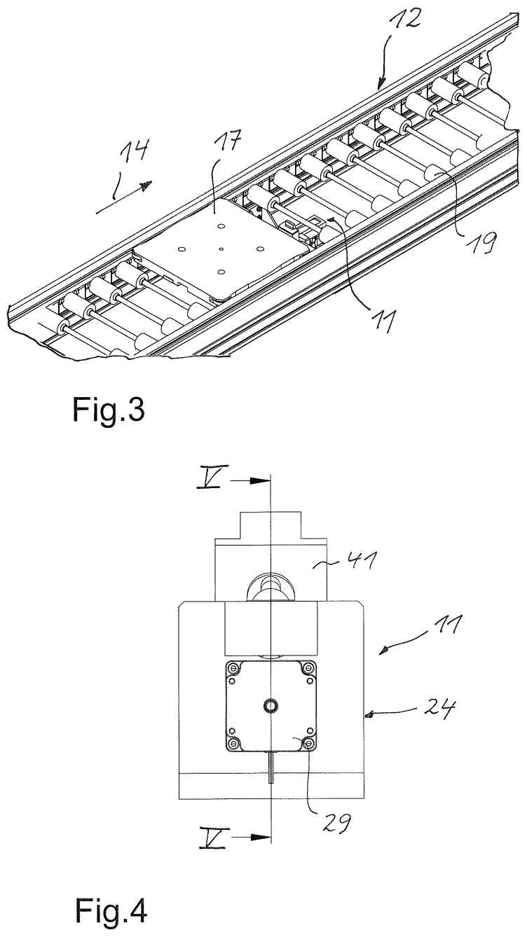

FIGS. 1 to 15 show a first embodiment of the stop module 11 according to the invention. The stop module 11 is preferably used in automatic processing and conveying devices, for example conveyor belts 12, such as those in the automotive industry, to separate moving objects 16 in a movement plane or transport plane 13 in a working movement direction 14, which is oriented along a movement axis 15. The objects 16 are usually workpiece carriers 17 or workpieces transported directly on the conveyor belt. The workpiece carrier 17 can, for example, be a workpiece pallet. The workpiece carrier 17 has a front workpiece carrier stop face 18 assigned to the stop module 11.

In the example shown, the workpiece carrier 17 runs on a multiplicity of transport rollers 19 arranged one behind the other in the working movement direction 14 and arranged below the transport level 13. The stop module 11 is arranged on the transport device 12, in particular by means of a crossbeam 20, in such a way that a stop element 21, which will be described in more detail below, projects into the transport plane 13 in its stop element initial position 22, the stop element 21 having a stop surface 23 that is aligned against the direction of the working movement 14, thus facing the workpiece carrier stop face 18.

The stop module 11 has a base body 24 which, as shown by the overview of FIGS. 1 and 2, is to be fastened to the crossbeam 20 of the transport device 12 by means of fastening means, for example fastening screws 25.

The base body 24 is a multi-part component and has a base part 26 which has a mounting plate 27, via which the stop module 11 can be attached to the crossbeam 20 of the transport device 12, as described above.

In the example shown, a supporting plate 28 extends from the fastening plate 27 of the base part 26, on which a setting drive 29, which will be described in more detail below, is arranged. The setting drive 29 has a longitudinal axis 30 which, in the example shown, extends parallel to the movement axis 15.

The stop element 21 is mounted on a stop element carrier 35 so that it can move relative to it. In the example shown, the stop element carrier 35 comprises two bearing bolts 47a, 47b, which are arranged parallel to one another, are in particular of circular cylindrical design and are in turn mounted on the base plate 37 by means of a pivot bearing so as to be pivotable about a pivot axis 36 running transversely to the longitudinal axis 30. The pivot bearing comprises two bearing seats formed in the base plate 37, in each of which the ends of the bearing bolts 47a, 47b are received in a pivotally movable manner. The bearing bolts 47a, 47b each have transverse bores 31a, 31b running perpendicular to their longitudinal axis, through which an associated pivot pin 32 is inserted in each case, which in turn is held in a channel 33 opening out on the front side of the base plate 37. The stop element carrier 35 and thus also the stop element 21 are thus movably mounted on the base body 24.

As described in more detail below, the stop element 21 can be moved out of the transport level 13 by means of the actuating drive via the downward stroke and back into it via the upward stroke.

In the example shown, the stop element 21 is mounted so that it can move relative to the stop element carrier 35, namely transversely to the longitudinal axis 30 and to the movement axis 15. The stop element 21 consists of a base body 41, for example in the shape of a cuboid, wherein the base body 41 has an upper side 42 and a lower side 43. A locking pawl 44, which in the initial position 22 of the stop element projects into the transport plane 15 and is wedge-shaped, for example, projects from the upper side 42. The stop face 23 is formed on the locking pawl 44 against the direction of the working movement 14.

The relative mobility of the stop element relative to the stop element carrier 35 is achieved by second spring means 45. In the example shown, two spring elements 46a, 46b are provided, which are supported on the stop element carrier 35 on the one hand and on the base plate 37 on the other hand, and whose spring force pushes the stop element 21 upwards away from the base plate 37, that is to say, pushes it into the position in which it projects into the transport plane 13, which may, for example, be the stop element carrier initial position 22. It is advantageous if the spring elements 46a, 46b are each formed as pressure springs, each of which is guided on the bearing bolts 47a, 47b.

The impact module 11 also has a damping device 48 coupled to the stop element 21, in particular to the stop element carrier 35.

The damping device 48 serves to damp the impact of an object 16 on the stop element 21, in such a way that the stop element 21 is movable in a damped manner upon impact of the object from the stop element initial position 22 in the direction of a stop element end position 49 preventing further movement of the stop element 21. Thus, for example, the impact of the workpiece carrier 17 on the pawl 44, that is to say the striking of the workpiece carrier stop 18 on the stop face 23 on the pawl 44, is damped. In this way, the movement of the incoming object 16, for example the workpiece carrier 17, is braked to a standstill.

An essential element of the stop module 11 is a mechanical control element 50, which is coupled in terms of movement to the actuating drive 29, wherein the mechanical control element 50 is coupled to a mechanical counter-control element 51 arranged on the stop element 21 in such a way that when the object 16 strikes, the actuating drive 29 can be activated by activation means and causes the mechanical control element 50 to execute a control movement, whereby the stop element 21 can be moved from the stop element initial position 22 into the stop element end position 49 by means of the pick-up by means of the mechanical counter-control element.

As a rule, the stop module 11 is set to the highest total energy (weight, speed and propelling force), so that an object with the highest total energy can be reliably decelerated and stopped in a damped manner. In this process, the stop element 21 is moved completely from the stop element initial position 22 to the stop element end position 49 by means of the total energy of the incoming object 16, for example the workpiece holder 17, where the stopped object 16 then comes to a final stop in the stop element end position 49.

If objects 16 arrive with less total energy, this total energy is not enough to move the stop element 21 completely from the stop element start position 22 to the stop element end position 49, that is to say, the stop element 21 remains in an intermediate position between the stop element initial position 22 and the stop element end position 49, with the result that the workpiece carrier 17 is also not in the defined end position. This is disadvantageous because the position of the stop element and thus the holding position of the object 16 are dependent on the total energy, so that the subsequent handling is made more difficult.

According to the first embodiment, the mechanical control element 50 is shown in the form of a control disc, for example.

As can be seen in particular from the overview of FIGS. 4, 5 and 8, the control disc is coupled to the output shaft 40 of the actuating drive 29 in such a way that a rotary movement of the output shaft 40 causes a rotary movement of the control disc.

In the example shown, the actuating drive 29 is represented as an electric actuating drive, in particular in the form of a geared stepper motor, and is described in more detail below.

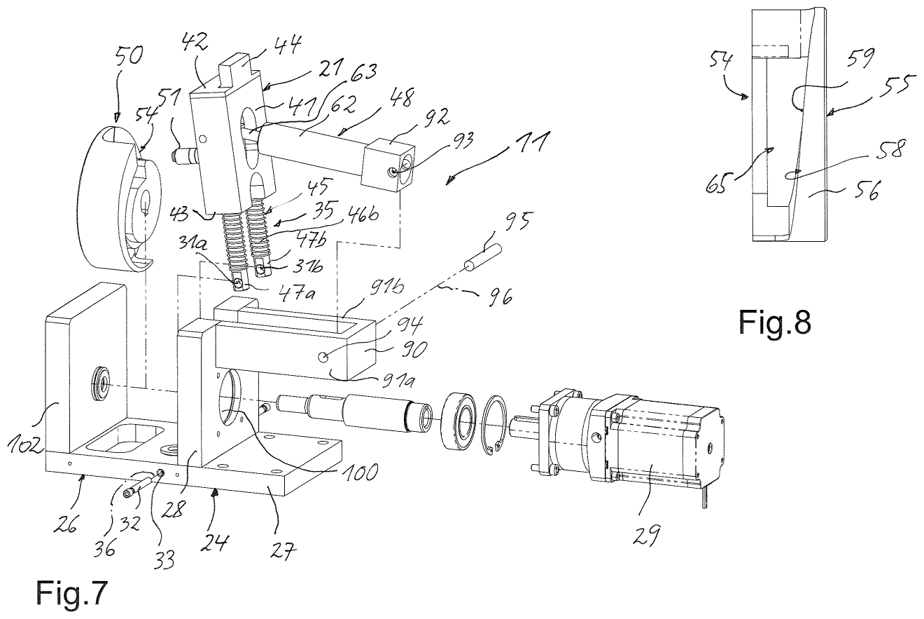

As exemplified in FIGS. 6 and 7, the control disc has a front disc surface 54 facing the actuating drive 29 in the coupled state with the output shaft 40 of the actuating drive 29 and a rear disc surface 55 lying opposite the front disc surface 54. Furthermore, the control disc also has a lateral surface 56. While the front disc surface 54 is characterised by its shape, as described in more detail below, the rear side is essentially flat. The control disc also has a keyhole-shaped central through-hole 57, through which the output shaft 40 passes. The control disc and the output shaft 40 are connected to one another in a rotationally fixed manner by means of a keyed connection with a key 34 and a groove 37 formed on the through-hole, whereby the rotary movement originating from the output shaft 40 is transmitted directly to the control disc.

An important aspect is that the control disc is equipped with a damping control gate 58, which has a control track, described in more detail below, for the mechanical counter-control element 51.

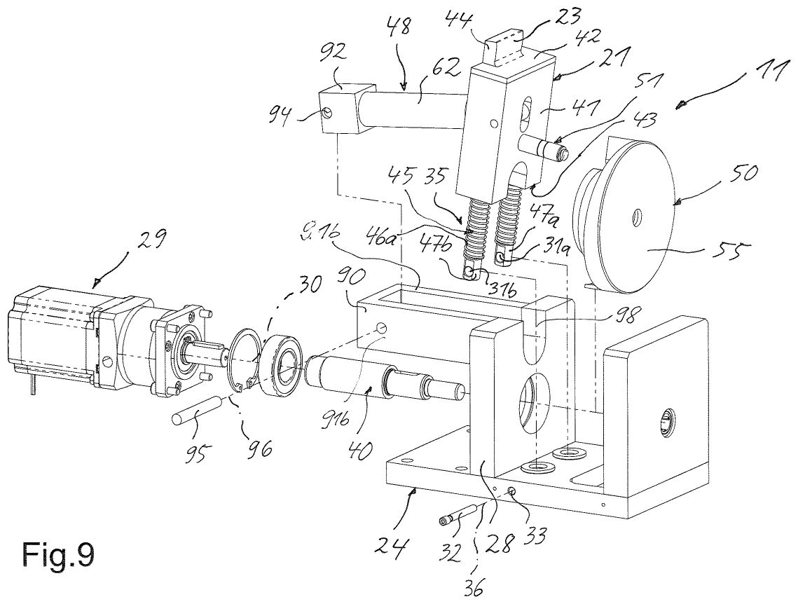

As shown in particular in FIGS. 7 and 9, the mechanical counter-control element 51 is designed as a control bolt that is arranged on the front side of the stop element 21 and projects forward from there.

For damping control, the control disc has the said damping control slot 58, which is located on the front disc surface 54. The damping control slot 58 has a control track in the form of an axial lead surface 59.

When the actuating drive 29 is activated, the control disc can be moved from a control element basic position 60, which corresponds to the stop element initial position 22, into a control element damping end position 61, which corresponds to the stop element end position 49. In the case of the control disc, the actuating drive 29 causes the control disc to turn through a specific angle of rotation, whereby, starting from the control element initial position 60, after covering the specific angle of rotation, the control element damping end position 61 is reached. In the illustrated example, the angle of rotation is 180°, but it can also be smaller or larger than 180°.

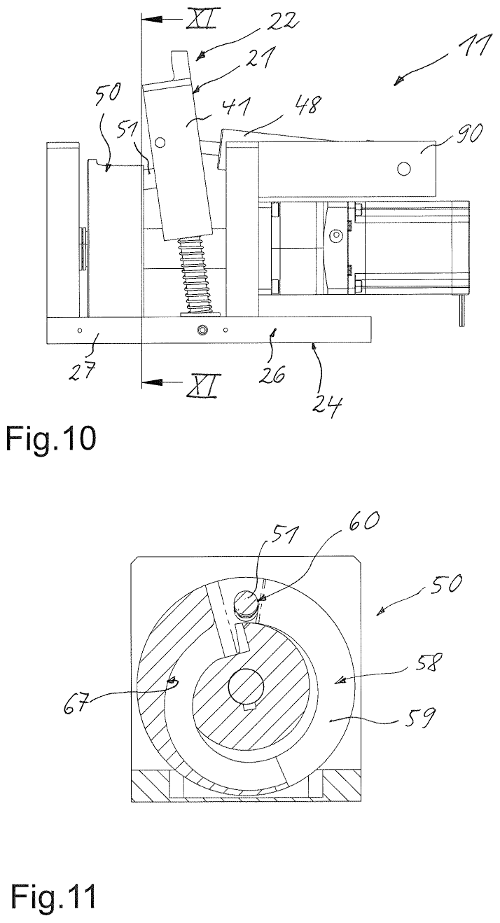

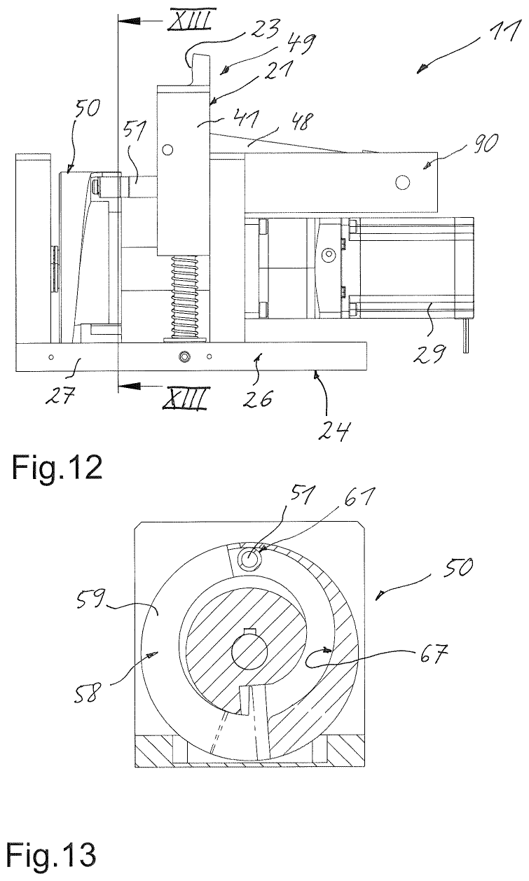

If the control bolt is in contact with the axial lead surface 59 on the control disc, it is guided along the axial lead surface 59, the pitch being designed such that the distance between the axial lead surface 59 and a plane passing through the supporting plate 28 decreases in the axial direction during rotation from the control element basic position 60 to the control element damping end position 61, as shown in the overview of FIGS. 10 and 12, causing the stop element 21 to be displaced into the stop element end position 49 due to the control bolt being guided along the axial lead surface 59, and thus, in the illustrated embodiment, to be pivoted into the stop element end position 49.

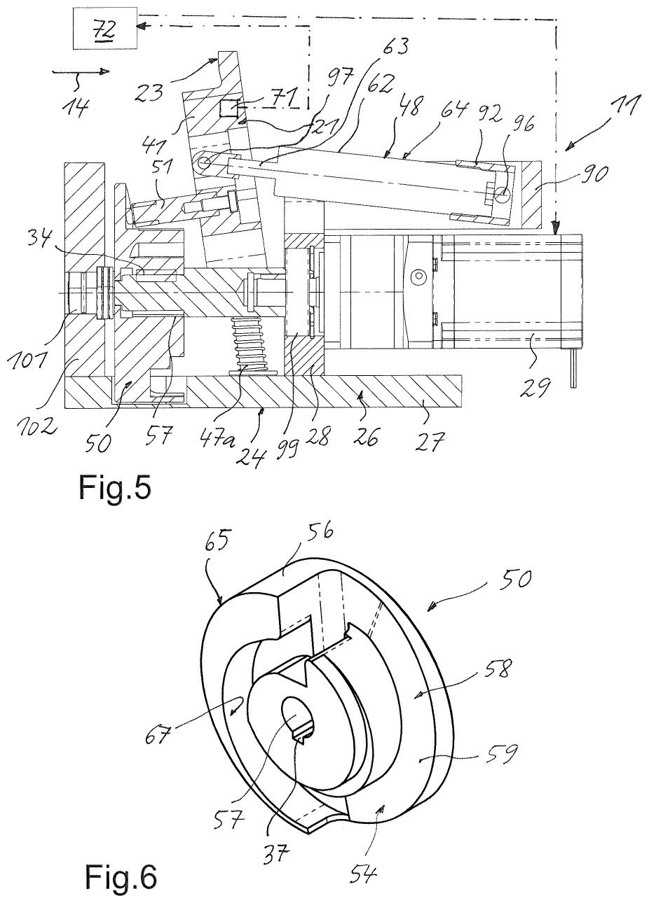

As shown in particular in FIG. 5, the stop module 11 has a damping device 48, which has a shock absorber 62. The shock absorber 62 is attached to the base body 24, in particular to the rear side of the supporting plate 37. As shown in particular in FIGS. 7 and 9, a fork-shaped damper carrier 90 is attached to the rear side of the supporting plate, which has two parallel carrier legs 91a, 91b, between which the shock absorber is received. The shock absorber 62 also has a bearing section 92, which is in particular of a cuboid design and is provided with a transverse bore 93, which is aligned with bores 94 in the support leg, so that a pivot bearing for the shock absorber is formed with the aid of a pivot bearing bolt 95 guided through the bores, so that it can pivot about a shock absorber pivot axis 96 when the stop element 21 moves when an object strikes it.

The shock absorber 62 also has a damper tappet 63 or a damper piston rod, which is also mounted on the base body 41 of the stop element 21 so as to be pivotable about a further pivot axis 97. The shock absorber passes through the supporting plate 28 via an opening 98 (FIG. 9) formed in the supporting plate 28 and open at the edge.

When the stop element 21 is moved in the direction of the stop element end position 49, the damper tappet 63 retracts into the damper housing and the movement of the stop element 21 that is initiated by the impact of the object on the stop element is damped. The shock absorber 62 is assigned first spring means 64, or these are integrated into the shock absorber 62, which bias the stop-member carrier 35 in the direction of the stop-member initial position 22, that is to say, in the case of no object is located at the stop element 21, the first spring means 64 push the stop element 21 back into the stop element initial position 22 if the control disc has rotated further out of the control element lowering end position 66 into the control element basic position 60.

In addition to controlling the damping movement of the stop element 21 via lowering control means, the mechanical control element also controls the lowering movement of the stop element 21 out of the movement plane.

In the example shown, the control disc has a lowering control slot 65 which follows on from the damping control slot 58 in the direction of rotation. In the first embodiment, the lowering control means are also formed by the control disc and the control bolt, in such a way that the control disc can be rotated further through a certain angle of rotation from the control element damping end position 61 to a control element lowering position 66, wherein during the rotation the control bolt is guided on a radial lead surface 67 extending radially to the longitudinal axis 30 or rotation axis, is formed on the lowering control cam 65 and guides the control bolt during rotation.

The aforementioned key connection couples the output shaft 40 of the actuator drive 29 to the control disc. The output shaft 40 is rotatably mounted on the base body 24 at two axially spaced points via a first pivot bearing 99 and a second pivot bearing 101. The first pivot bearing 99 is located on the supporting plate 28, which has a central bearing hole 100 for this purpose. The second pivot bearing 101 is located on an end plate 102, which is aligned in particular parallel to the supporting plate and also belongs to the base body 24. Consequently, the control disc is accommodated in the space between the supporting plate 28 and the end plate 102.

As already mentioned, the actuating drive can be activated by activation means, so that the output shaft 40 is set in a rotary movement and this rotary movement is transmitted to the control disc via the previously described feather key connection. The activation means comprise a sensor 71, which is shown only schematically in FIG. 5, where a sensor is shown here as an example that responds to the movement of the stop element initiated by the impact. The sensor is able to detect the impact of the object, for example of the workpiece carrier 17 on the stop element, and to transmit a corresponding sensor signal to an electronic control unit 72 (FIG. 5).

The electronic control unit 72 is suitable for receiving sensor signals transmitted by the sensor, in particular in the event of an impact, and for outputting activation signals for activating the actuating drive 29.

The mode of operation of the impact module 11 is shown in particular in FIGS. 5 to 16 and can be described as follows:

Initially, the impact member 21 is in the impact member initial position 22, with the pawl 44 projecting into the transport plane 13. As shown in FIG. 11, the control disc is in the control element initial position 60 at the lowest point of the axial incline 59. When an object, for example the workpiece holder 17, in which the workpiece holder stop 18 strikes the stop surface 23 of the locking pawl 44, this is detected by the sensor 71 and transmitted to the electronic control unit 72 by means of a sensor signal, whereupon the electronic control unit 72 activates the actuating drive 29 so that the output shaft 40 is set in a rotary movement through a specific angle of rotation.

As a rule, the impact member 21 is moved a little way towards the impact member end position 49 by the impacting object, so that the control bolt does not initially rest against the axial pitch surface 59. However, the control disc rotates independently of this, so that if the stop element 21 is not moved completely to the stop element end position 49 by the total energy of the impacting object, the control bolt will come into contact with the axial lead surface 59 at some point. From then on, the control bolt is guided along the axial slope surface 59, causing the stop element 21 to swing into the stop element end position 49 in any case, regardless of the total energy, i.e. in particular the weight of the impacting object 16. It is useful for the control disc to rotate between the control element's initial position 60 and the control element's damping end position 61 not at a constant speed but initially at a higher speed and at the end of the damping movement at a lower speed.

When the stop element 21 is in its stop element end position 49, the struck object 16 is braked to a standstill. This is independent of the total energy of the struck object, so that the stop element end position 49 is always assumed.

If the attached object 16, for example the attached workpiece holder 17, is to be released again, a downward stroke of the stop element 21 out of the transport level 13 is required.

The control disc is also used for this purpose. In the example shown, the control disc has travelled through an angle of rotation of approximately 180° between the stop element initial position 22 and the stop element end position 49. The control bolt is located at the uppermost point of the axial pitch surface 59. During the subsequent rotation, the control bolt moves into the radial pitch surface 67, as shown in FIG. 17.

Due to the spiral shape of the radial slope surface 67, the control bolt is displaced in the direction of the axis of rotation when the control disc continues to rotate, causing the stop element 21 to be moved out of the transport plane 13 and into a release position against the spring force of the second spring means 45.

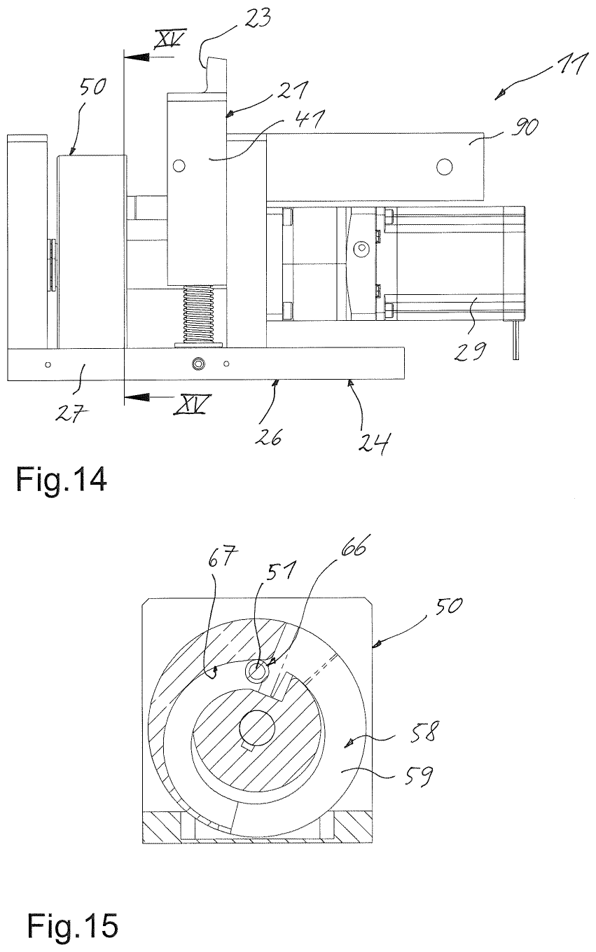

FIGS. 14 and 15 show the control disc in the control element lowering end position 66, which corresponds to a release position of the stop element. When the stop element 21 is in the release position, the stopped object 16 is released again and can be moved further in the working movement direction 14 by means of the transport device 12.

If the next object 16 is to be released or stopped, the stop element must be returned to the stop element initial position 22, which is also achieved by the further movement of the control disc. If the control disc is turned further from the control element lowering position 66 by a relatively small angle of rotation, the control bolt disengages from the radial pitch surface 67, causing the stop element to be moved back into the transport plane 13 as a result of the spring force of the second spring means 45. At the same time, the control bolt reaches the lowest point of the axial pitch surface 59, so that the first spring means 64 cause the stop element to be returned to the stop element initial position 22.

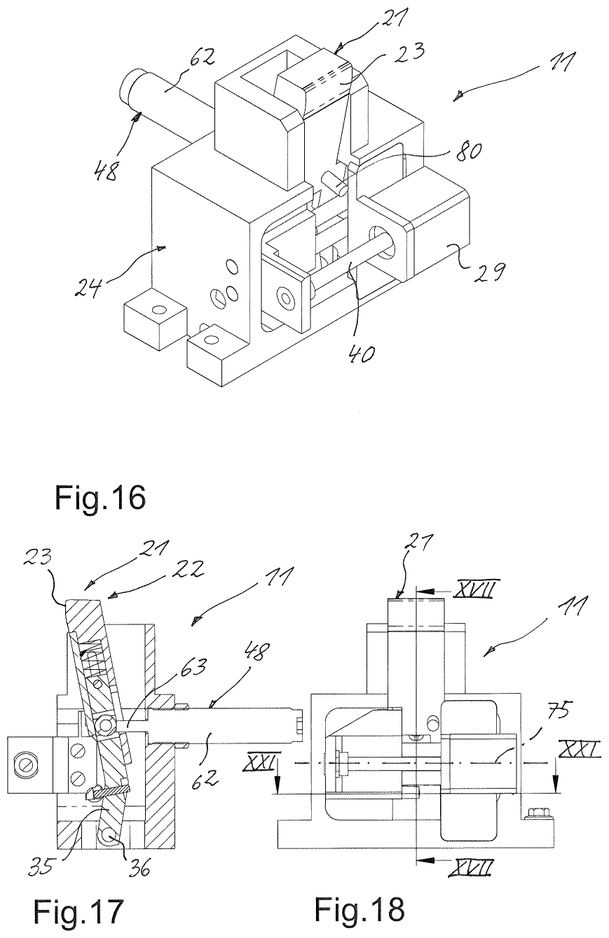

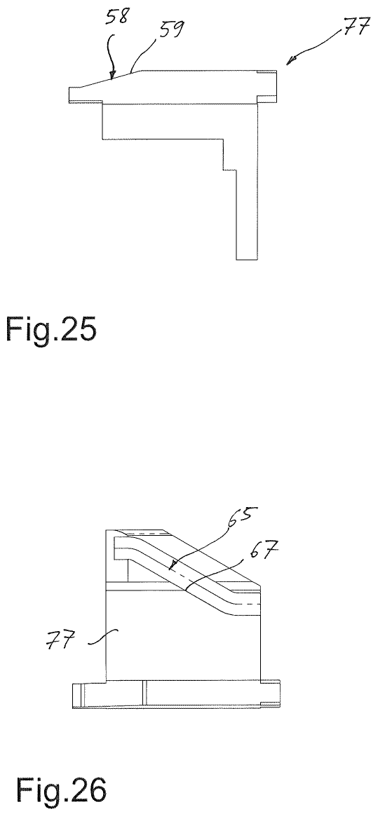

FIGS. 16 to 26 show a second embodiment of the invention's stop module 11. The second embodiment differs from the first embodiment mainly in that the mechanical control element is designed differently. Whereas in the first embodiment described above a control disc is used as the mechanical control means, in the second embodiment described below a mechanical control element 50 is used in the form of a carriage 76 that can be displaced along a linear axis 75 that is aligned transversely to the movement axis 15.

The structure of the rest of the stop module 21 is similar to the structure of the stop module 21 in the first embodiment, so it will not be discussed in detail here. In any case, the stop element 21 is also pivotally mounted on the base body 24 and can be pivoted between a stop element initial position 22 and a stop element end position 49. Furthermore, the stop element 21 is mounted so that it can move relative to a stop element carrier 35, with second spring means 45 being provided here in turn, which press the stop element 21 into the transport plane 13.

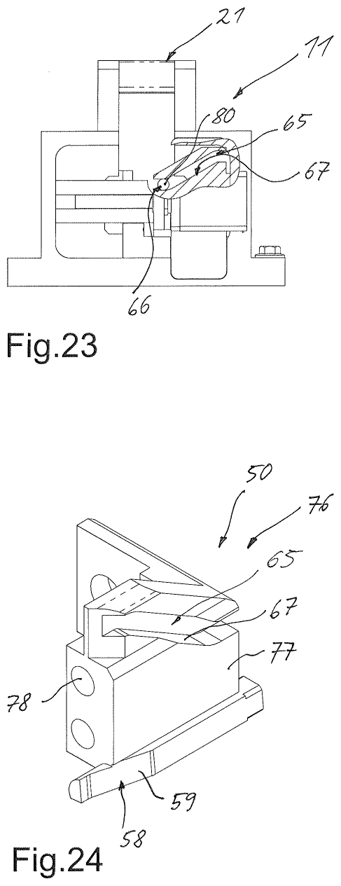

The actuating drive 29 is configured as a linear drive and has an output shaft 40 configured, for example, as a threaded spindle, on which the carriage 76 is mounted in a linearly adjustable manner. The slide is shown in FIGS. 23 to 26 as an example. The slide 76 has a base body 77, which is penetrated, for example, by two channels 78 aligned parallel to the linear axis 75, which in turn are penetrated by two guide shafts 79 mounted on the base body. On the underside of the base body 77 is a damping control gate 58, which has an axial incline surface 59 that interacts with a control bolt arranged on the stop element carrier 35.

The lowering control slot 65 is formed on the upper side of the base body 77 and is part of the lowering control means. The lowering control slot 65 has a radial slope surface 67 that is aligned in the radial direction to the axis of movement 15. The slope of the radial slope surface decreases along the direction of movement of the slide 76 along the linear axis 75. A slide follower 80 in the form of a guide bolt is guided on the radial slope surface 67, which is connected to the stop element carrier.

The mode of action or function of the second embodiment can be described as follows:

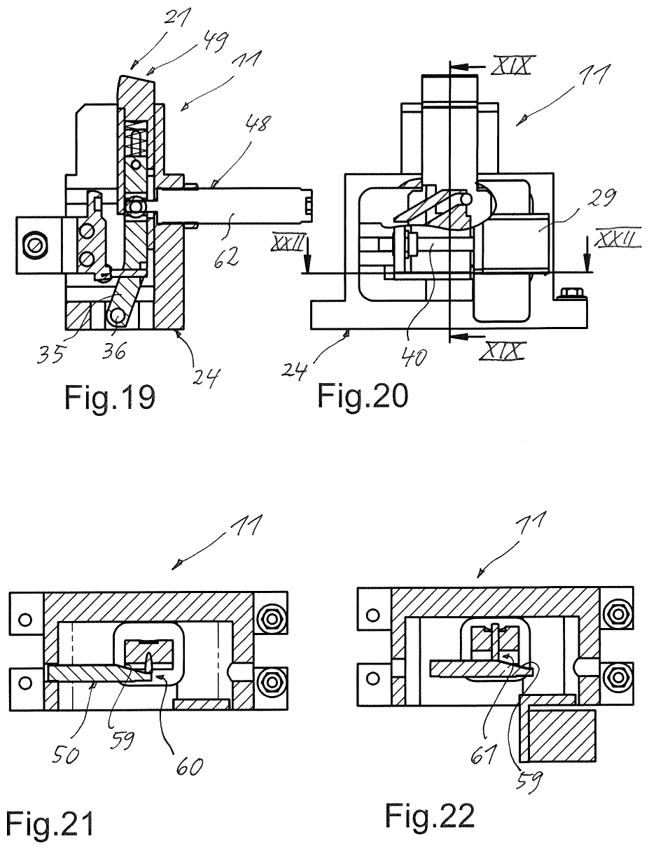

Initially, the stop element 21 is in the stop element initial position 22, as shown in FIG. 17 by way of example. When an object 16 strikes the stop element, the activation means in turn drive the linear drive, causing the carriage 76 to perform a linear movement along the linear axis 75. In this process, the control bolt slides along the axial pitch surface 59, so that the stop element 21 is adjusted completely into the stop element end position 49, independently of the weight of the object being attached, starting from the stop element initial position 22. This situation is shown in FIG. 19.

To release the object, for example the workpiece holder, carriage 77 is moved further in the direction of movement along linear axis 75, causing the sliding follower to engage in lowering control cam 65, where it is forced downwards by radial pitch surface 67, causing stop element 21 to be moved out of transport plane 13.

After the object 16 has been released, the stop element 21 can then be moved back into the transport plane by means of the associated spring means and there into the stop element initial position 22.

1. A stop module with a stop element mounted on a base body so as to be movable for objects moving in a transport plane in a current working movement direction oriented along a movement axis, wherein the stop element can be moved out of the transport plane and back into it by means of an actuating device comprising an actuating drive by means of a downward and upward stroke, and with a damping device coupled to the stop element for damping the impact of an object on the stop element, such that the stop member is movable in a damped manner upon impact of the object out of a stop member initial position in the direction of a stop member end position preventing further movement of the stop member,
wherein the actuating device has a mechanical control element which is coupled in terms of movement to the actuating drive, is driven by the latter and is coupled to a mechanical counter-control element, arranged on the stop element, in such a way that when the object strikes, the actuating drive can be activated by activation means and causes the mechanical control element to execute a control movement, whereby the stop element can be moved from the stop element initial position into the stop element end position via the tap by means of the mechanical counter-control element.

2. The stop module according to claim 1, wherein the mechanical control element and the mechanical counter-control element are designed as a control bolt and a damping control link equipped with a control track for the control bolt.

3. The stop module according to claim 2, wherein the mechanical control element has the damping control link and the mechanical counter-control element has the control bolt.

4. The stop module according to claim 1, wherein the mechanical control element is movable by a control movement upon activation of the actuating drive from a control element initial position corresponding with the stop element initial position into a control element damping end position corresponding with the stop element end position.

5. The stop module according to claim 2, wherein the control track of the damping control slot is formed as an axial lead surface with a lead extending axially to the axis of movement which, starting from the control element basic position and towards the control element damping end position, rises in the direction of a supporting plate of the basic body.

6. The stop module according to claim 1, wherein the mechanical control element also takes over control of the lowering movement of the stop element out of the transport plane in addition to control of the damping movement of the stop element by lowering control means.

7. The stop module according to claim 6, wherein the lowering control means comprise a lowering control gate and a lowering control bolt.

8. The stop module according to claim 5, wherein the mechanical control element is configured as a control disc rotatable about an axis of rotation, wherein the control element damping end position is attainable from the control element basic position by rotation of the control disc through a specific angle of rotation, for example 180°, can be achieved.

9. The stop module according to claim 8, wherein the damping control link is formed on the control disc on a first end face of the control disc facing towards the control bolt.

10. The stop module according to claim 8, wherein the lowering control means are formed by the control disc and the control bolt, in such a way that the control disc, starting from the control element damping end position, can be rotated further through a specific angle of rotation towards a control element lowering end position, wherein, during the rotation, the control bolts can be guided along a radial pitch surface extending radially to the longitudinal axis and formed on the lowering control link.

11. The stop module according to claim 1, wherein the mechanical control element is designed as a carriage that can be displaced along a linear axis that is aligned transversely to the axis of movement, on which carriage the damping control link is formed.

12. The stop module according to claim 1, wherein the activation means comprise at least one sensor for detecting the impact of an object on the stop member and an electronic control unit, wherein the electronic control unit is adapted to receive sensor signals transmitted by the sensor and to output activation signals for activating the actuating drive.

13. The stop module according to claim 1, wherein the actuating drive is designed as an electrical or fluidic actuating drive, preferably an electric motor.

14. The stop module according to claim 8, wherein the actuating drive has an output shaft that can be driven in rotation and whose rotary driving movement can be transmitted to the control disc.

15. The stop module according to claim 1, wherein the damping device comprises a shock absorber coupled to the stop member.

16. The stop module according to claim 1, wherein the stop element is associated with first spring means for prestressing the stop element into the stop element initial position, wherein preferably the spring means are components of the damping device.

17. The stop module according to claim 1, wherein the stop element is assigned second spring means acting against the downward stroke for prestressing the stop element into the stop element initial position projecting into the transport plane.

18. The stop module according to claim 1, wherein the stop element is mounted on the base body so as to be pivotable by means of a pivot bearing about a pivot axis between the stop element initial position and the stop element end position.
